(19) United States
(12) Patent Application Publication
(10) Pub. No.: US 2005/0260412 A1
(43) Pub. Date: Nov. 24, 2005

(54) System, method, and apparatus for producing high efficiency heat transfer device with carbon nanotubes

(75) Inventor: Slade H. Gardner, Fort Worth, TX (US)

Correspondence Address: BRACEWELL & PATTERSON, L.L.P., Suite 2900, 711 Louisiana Street, Houston, TX, 77002-2781, US

(73) Assignee: Lockheed Martin Corporation

(21) Appl. No.: 10/848,875

(22) Filed: May 19, 2004

(51) Int. Cl. B32B 9/00; B32B 15/04

(52) U.S. Cl. 428/408; 428/457; 428/336

(57) ABSTRACT

A high efficiency heat transfer device utilizes carbon nanotube deposits that are formed directly on the outer surface of the device to replace conventional cooling fins. A catalyst is used to facilitate retention of the nanotubes on the device before they are deposited. In addition, the nanotubes are infused with a protective outer layer, such as silicon. The protective layer penetrates the deposition, fills-in the voids between nanotubes, and then deposits on the surface of the nanotubes layer.

### BACKGROUND OF THE INVENTION

1. Technical Field

The present invention relates in general to an improved heat transfer device and, in particular, to an improved system, method, and apparatus for producing a carbon nanotube-based heat transfer device that has a higher efficiency than prior art heat transfer devices.

2. Description of the Related Art

Heat transfer is a critical issue in aeronautic and space systems. Heat transfer devices must be efficient and lightweight for these types of applications. Heat transfer devices, such as tubing, are typically made from metals having high thermal conductivity. The outer surface of a heat transfer device is usually smooth and commonly bonded or attached to cooling fins. The cooling fins are also commonly made of metals with high thermal conductivity. It is well known that increased surface area on heat transfer devices leads to improved heat transfer. The cooling fins are designed to increase the effective surface area for heat transfer.

There have been many attempts to improve the thermal conductivity of conventional heat transfer devices. One area of technology that holds promise for an enhanced solution but has heretofore been unsuccessfully applied, is nanotechnology. In particular, nanotubes, such as single-walled carbon nanotubes (swcnt), have had a number of successful commercial applications in other areas of industry. However, the production of swcnt is substantially limited to an experimental scale with some production rates being on the order of only grams per day.

There are several different processes that are used for swcnt production, such as laser ablation methods, arc discharge methods, and chemical vapor deposition (CVD) methods. Some of these prior art processes have also combined plasma generation, thermal annealing, and the use of various transition metal catalyst supports with one of the three techniques. See, e.g., U.S. Pat. Nos. 6,645,628; 6,451,175; 6,422,450; 6,361,861; 6,232,706; and 6,221,330; and published U.S. Patent Application Nos. 2002/0055010; 2002/00578; 2002/0102353; and 2002/0151030.

There are also a number of problems with these existing, prior art methods. Many of them are batch-type processes that are capable of producing product only once per cycle, rather than producing a continuous supply of end product, which would be far more desirable. As a result, the rates of production are relatively low, with some methods generating only enough product to scarcely conduct laboratory testing on the end product. Consequently, it would be very difficult if not impossible to scale these methods up to industrial quantity production levels. Furthermore, these production methods result in a batch of material that must then be post-processed into a final device form, requiring several additional processing steps to form carbon nanotubes into a useful product for application.

The scalability of production methods is critical for many potential industrial applications for swcnt. A few examples include high performance structures manufacturers, such as those in military, aerospace, motor sports, marine, etc., fabrication businesses and, more generally, materials suppliers. The inability to make large quantities of swcnt affordable inherently limits their applications to uses as reinforcements for composites and the like. Composites that are reinforced with swcnt also have a number of limitations, including fiber/matrix adhesion problems, strength limitations due to matrix design, and only providing incremental improvements in other areas of performance. Furthermore, some prior art methods of producing swcnt make a resultant product that is the relatively low in purity. Nonetheless, an improved system, method, and apparatus for producing a carbon nanotube-based heat transfer device that has a higher efficiency than prior art heat transfer devices would be desirable.

### SUMMARY OF THE INVENTION

One embodiment of a system, method, and apparatus of the present invention for producing a high efficiency heat transfer device utilizes carbon nanotube deposits. The carbon nanotubes, which may be single-walled, multi-walled, or other types of structures, are formed directly on the heat transfer device substrate and replace conventional cooling fins. The carbon nanotubes grow in a substantially perpendicular direction from the outer surface of the heat transfer device without the need for being in an evacuated environment. Carbon nanotubes have a thermal conductivity that is an order of magnitude greater than metals as they transmit heat along their axes. They also have much greater surface area than is possible with cooling fins, further adding to the improved heat transfer capability of the final device.

One process for directly forming carbon nanotubes (see U.S. patent application Ser. No. 10/455,767) is capable of depositing an anisotropic coating of the carbon nanotubes on a surface is utilized. The apparatus used in the present invention directly deposits a controlled morphology of carbon nanotubes onto the surface of a heat transfer device, such as tubing. This deposition provides a dramatic improvement in thermal conductivity from the tubing to the ambient environment or lower temperature zone.

In one embodiment, the surface area of the heat transfer device is uniformly coated with a very dense deposition of carbon nanotubes at a depth of approximately 150 microns. To facilitate the deposition, a catalyst is first applied to the outer surface and the surface or device is heated to a selected temperature for proper nanotubes growth. Some of the possible catalysts include transition metals such as Fe, Co, Mo, Ni, Y, etc. In one embodiment, a transition metal salt can be dissolved in water for application to the heat transfer device outer surface and then heated to pyrolyze the organic component of the salt. For example, the catalyst may be applied by dipping a heat transfer tube in a Fe₂(SO₄)₃ solution, heating it in a furnace (e.g., 700° C.) to burn off sulfates, and then placing it in a carbon plasma jet atmosphere to form the nanotubes thereon. Thus, the heat transfer device itself must be formed from a material (such as iron, graphite, copper, bronze, etc.) with good thermal conductivity and which can withstand the high temperatures needed to grow the nanotubes.

Alternatively, retention of the nanotubes on the heat transfer device and device durability may be facilitated by an additional layer, such as a silicon deposit (by, e.g., sputtering, etc.). The nanotubes may be infused with a protective layer for the deposition so that it is not rubbed off the surface. The protective layer may comprise silicon, ceramic, any metal, such as gold, silver, diamond, or a carbon allotrope. A carbon allotrope, like diamond from chemical vapor deposition, can be deposited by a relatively lower temperature CVD process that bonds the nanotubes together and provides additional heat transfer to the underlying component.

The protective layer penetrates into the depths of the deposition, fills-in the voids between nanotubes, and then deposits on the surface of the nanotubes layer. The extent of the “filling in” is controlled with parameters such as residence time. Furthermore, a small amount of material may be deposited in such a way that the voids are somewhat filled in and the top surfaces of the nanotubes are still exposed to facilitate heat transfer out of the cylindrical walls of the nanotubes.

When all three layers of the present invention are employed in an embodiment, the outer surface of a heat transfer device is provided with a catalyst layer having a thickness of, for example, 2 to 50 mm, beneath a layer of nanotubes having a thickness of about 5 microns to 1 mm (but typically on the order of about 200 microns or less), beneath or with a bonding layer having a thickness of approximately 30 microns.

The present invention also has a lower manufacturing cost than prior art solutions since there is no need to machine and assemble cooling fins. In addition, the overall size or space required by the present invention is significantly smaller than prior art designs since the carbon nanotube coating does not need as much projected area. This advantage is attributable to the large surface area of the high aspect ratio carbon nanotubes.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a schematic sectional side view of one embodiment of heat transfer device constructed in accordance with the present invention.

FIG. 2 is a highly magnified side view of another embodiment of a substrate having a dense deposition of carbon nanotubes formed thereon and is constructed in accordance with the present invention.

FIG. 3 is a highly magnified side view of another portion of the substrate and nanotubes deposition of FIG. 2 and is constructed in accordance with the present invention.

FIG. 4 are highly magnified side views of still other portions of the substrate and nanotubes deposition of FIG. 2 showing large, uniform areas of deposition.

FIG. 5 is a highly magnified side view of another alternate embodiment of a substrate and nanotube deposition that is infused with silicon and is constructed in accordance with the present invention.

FIG. 6 is a further magnified view of the embodiment of FIG. 5 and is constructed in accordance with the present invention.

FIG. 7 is a simplified flowchart for a method of the present invention.

FIG. 8 is a sectional diagram of one embodiment of a system for continuous synthesis of carbon nanotubes that may be used to form the present invention.

FIG. 9 is an enlarged diagram of an initial region of the system of FIG. 8.

FIG. 10 is a partially sectioned view of one embodiment of an atmospheric pressure plasma jet reactor for producing and stabilizing carbon plasma leading to the formation and growth of carbon nanotubes.

FIG. 11 is a schematic drawing of an alternate embodiment of a substrate and nanotube deposition that is infused with silicon and is constructed in accordance with the present invention.

### DETAILED DESCRIPTION OF THE INVENTION

U.S. patent application Ser. No. 10/455,767, filed Jun. 5, 2003, and entitled, “System, Method, and Apparatus for Continuous Synthesis of Single-Walled Carbon Nanotubes,” is incorporated herein by reference.

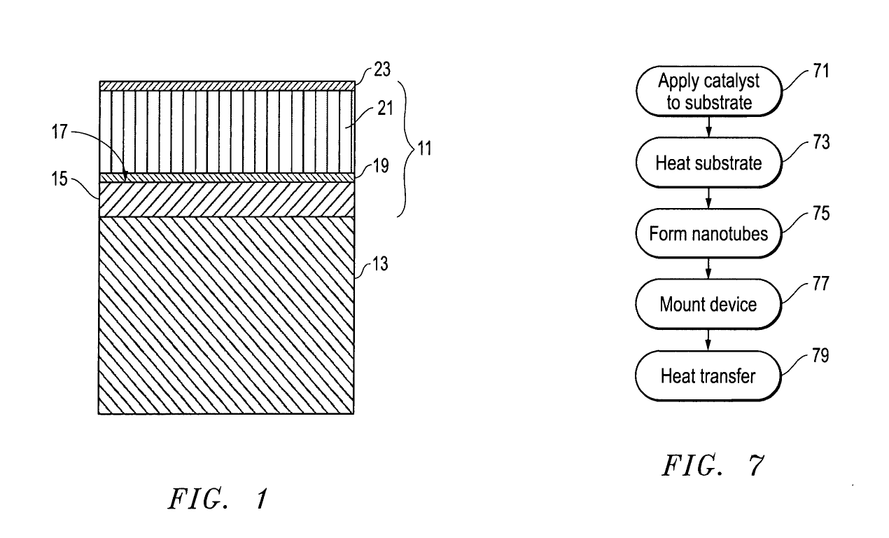

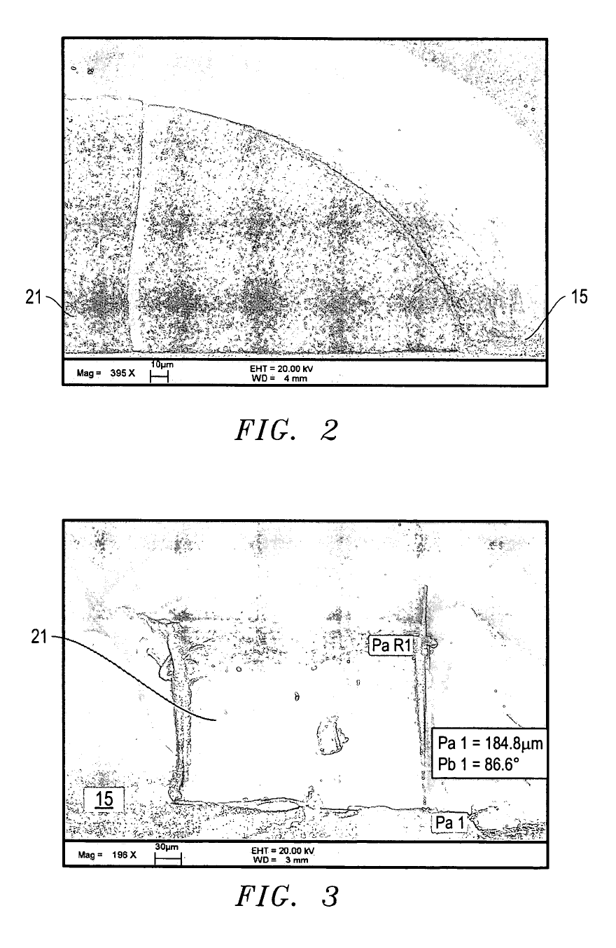

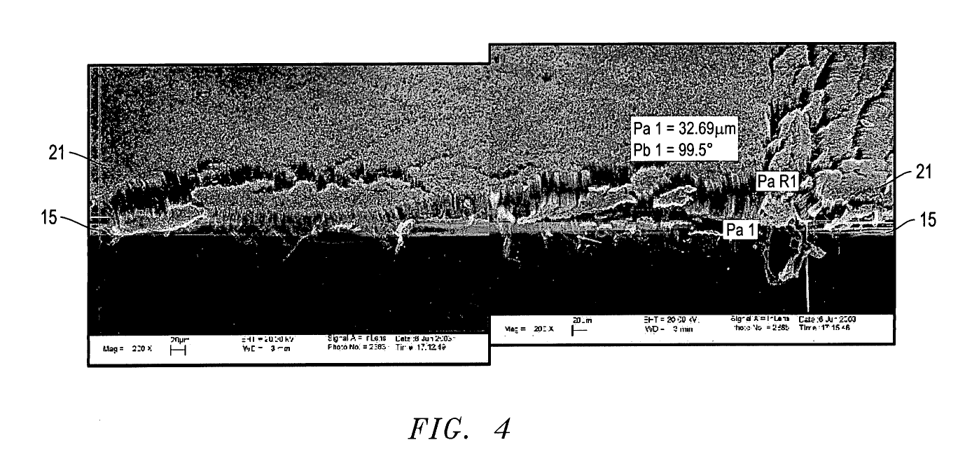

Referring to FIG. 1, one embodiment of an apparatus or heat transfer device 11 for dissipating heat from an object 13 is shown. For example, device 11 may comprise hollow tubing 15 for conducting heat away from liquid 13 that flows through it, or a solid apparatus 15 that is mounted to a solid object 13. The device 11 comprises a base or substrate 15 having an outer surface 17 and is adapted to be mounted to or in close contact with the object 13. When the object 13 generates or dissipates heat, the device 11 conducts the heat away from the object 13. The substrate may be formed from a thermally conductive material such as iron, graphite, copper, or bronze.

The device 11 has a catalyst 19 on the outer surface 17 of the substrate 15. The catalyst may be a transition metal such as Fe, Co, Mo, Ni, or Y. The device 11 also has carbon nanotubes 21 uniformly grown on the catalyst 19 and, thus, the substrate 15. The carbon nanotubes 21 generally extend away from the outer surface 17 of the substrate 15. In one embodiment, the carbon nanotubes are substantially perpendicular to the outer surface 17, such that the carbon nanotubes 21 conduct heat away from the substrate 15 and, thus, the object 13 along axial lengths of the carbon nanotubes 21. The heat transfer properties of the carbon nanotubes 21 are sufficient to eliminate the need for conventional cooling fins on the object 13. The carbon nanotubes 21 may comprise single-walled carbon nanotubes, multi-walled carbon nanotubes, or still other structures.

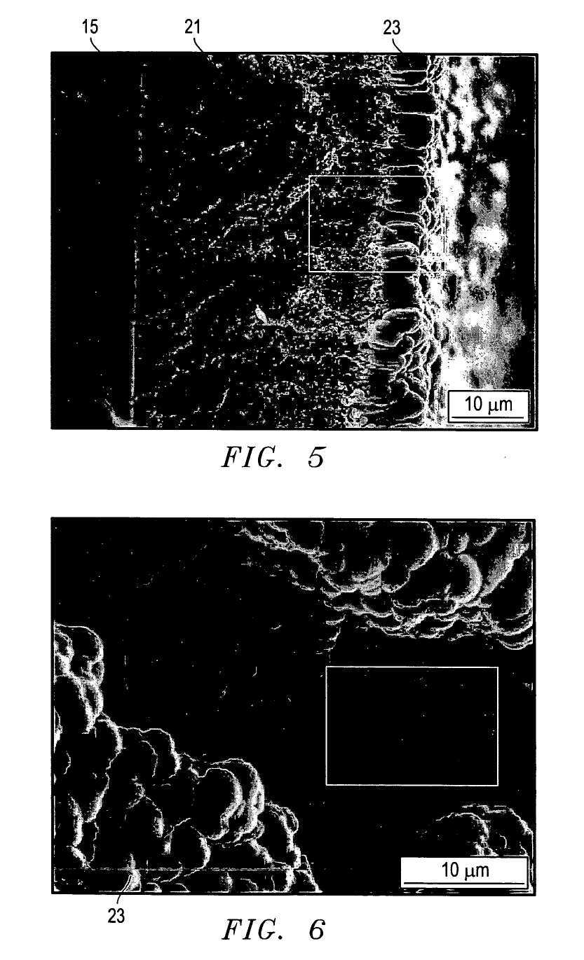

The device 11 optionally comprises a protective layer 23 that is formed on or in the carbon nanotubes 21 to facilitate retention of the carbon nanotubes 21 on the substrate 15. The protective layer 23 may be a metal or a carbon allotrope, such as silicon, gold, silver, or diamond. In one embodiment, the protective layer 23 penetrates into the carbon nanotubes 21, fills voids between the carbon nanotubes 21, and deposits on an outer surface of the carbon nanotubes 21 (FIGS. 5 and 6).

The heat transfer device 11 may be configured for many different applications. For example, in one embodiment, the catalyst 19 has a thickness (relative to the surface 17 of substrate 15) of approximately 2 to 50 nm, the carbon nanotubes 21 have a thickness of approximately 5 microns to 1 mm, and the protective layer 23 has a thickness of approximately 30 microns. However, the thickness of the carbon nanotubes 21 is typically on the order of about 200 microns or less for most applications.

In another embodiment of the present invention, the device 11 comprises a layer of carbon nanotubes 21 having a thickness of approximately 5 to 30 nm. The nanotubes 21 are infused with a material 24 (FIG. 11), such as silicon, gold, silver or diamond, to a fraction of the height of the carbon nanotube deposition 21. In this embodiment, the protective infused material 24 fills the carbon nanotubes 21 at the base 26 of the deposition 21. However, the outer portions of the carbon nanotubes 21 remain exposed for heat transfer. This configuration can be produced by controlling the deposition and infusion process of the silicon, gold, silver or diamond. Alternatively, this configuration may be produced by completely infusing and coating the carbon nanotubes 21, and then etching the surface layers such that the infused material 24 is removed from the outer portions of the carbon nanotubes 21.

The present invention also comprises a method (FIG. 7) of forming and utilizing a heat transfer device 11. One embodiment of the method comprises applying a catalyst 19 to a substrate 115 (block 71) and heating the substrate 15 (block 73) to a selected temperature to facilitate carbon nanotube growth. For example, the substrate 15 may be dipped in a solution and heated in a furnace (at, e.g., approximately 700° C.) to burn off nitrates, acetates, and/or sulfates. The method further comprises uniformly depositing and growing carbon nanotubes 21 on the catalyst 19 (block 75) such that the carbon nanotubes 21 extend away from the substrate 15. The substrate 15 may be placed in a plasma jet atmosphere to form the carbon nanotubes 21 thereon. However, these process steps do not necessarily have to take place in an evacuated environment.

The method optionally comprises selecting a material of the catalyst 19 from Fe, Co, Mo, Ni, and Y, and forming the carbon nanotubes 21 as either single-walled carbon nanotubes or multi-walled carbon nanotubes. The method also optionally comprises providing the catalyst 19 with a thickness of approximately 2 to 50 nm, and growing the carbon nanotubes 21 to a thickness of approximately 5 microns to 1 mm.

One embodiment of the method further comprising forming a protective layer 23 on the carbon nanotubes 21 to enhance the durability of the carbon nanotubes 21 on the substrate 15. The forming step may comprise depositing a carbon allotrope at a relatively lower temperature CVD process that bonds the carbon nanotubes 21 together and provides adhesion to the substrate 15, or depositing a small amount of protective layer 23 to partially fill in voids between the carbon nanotubes 21, and exposing top surfaces of the carbon nanotubes 21 to transfer heat out of cylindrical walls of the carbon nanotubes 21. The extent of the filling in the voids between the carbon nanotubes 21 in the forming step is controlled with parameters such as residence time. The forming step also may comprise selecting the protective layer 23 from silicon, gold, silver, and diamond, and penetrating the protective layer 23 into the carbon nanotubes 21, filling voids between the carbon nanotubes 21, and depositing on an outer surface of the carbon nanotubes 21. As described above for FIG. 11, the surface of the infused carbon nanotube layer also can be etched to remove the top layers of infused material to expose the outer portions of the nanotubes for more efficient heat transfer.

To utilize the device 11, the method comprises mounting the substrate 15 to an object 13 (block 77) that dissipates heat, and then conducting heat (block 79) away from the object 13 via the substrate 15 along axial lengths of the carbon nanotubes 21.

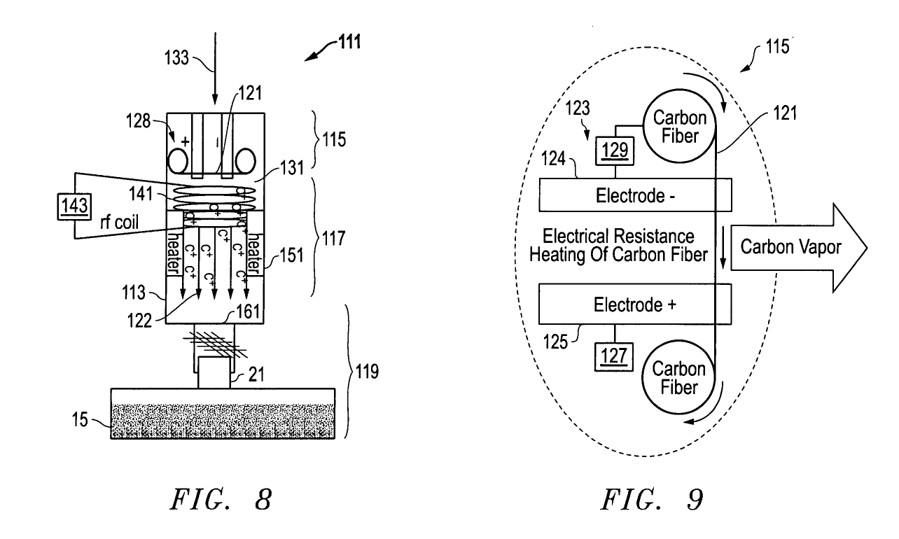

Referring now to FIGS. 8 and 9, one version of a system for producing the carbon nanotubes 21 is shown. The system typically uses a three-step process of carbon plasma generation, plasma stabilization, and product deposition, all of which are scalable to large, industrial volume production levels. Apparatus 111 comprises a continuous operation, flow-through reactor 113 having an initial region 115 (see FIG. 9), a plasma stabilization region 117, and a product formation region 119. The product formation region 119 is located immediately downstream from the plasma stabilization region 117. A feedstock 121 is located in the initial region 115 and is designed and adapted to be continuously supplied to the reactor 113. The feedstock 121 may comprise many different types and forms of material, but is preferably a carbon or graphite fiber feedstock, graphite electrodes, and may be supplied in the form of rod stock or fiber, for example. The feedstock also may include organic precursors such as ethylene, methane, hexane, octane, and the like, which are supplied as a separate feedstream 128 (FIG. 8) in place of the carbon feedstock 121.

In the system shown, the apparatus 111 utilizes an electrical resistance heater 123 to form the plasma 122. The electrical resistance heater 123 is mounted to the reactor 113 for passing low voltage, high current, electric power through the feedstock 121 over two oppositely-charged electrodes 124, 125, such that the feedstock 121 is rapidly resistance-heated. The electric power is regulated by feedback control 127 from an ultra-high temperature pyrometer 129 for measuring a temperature of the feedstock 121 to maintain a peak temperature of approximately 3000° C.

The reactor 113 may use a reduced pressure inert atmosphere 131 of continuously-flowing gas through supply 133. The gas may comprise argon, helium, nitrogen, or other inert gases. Control of a feed rate of the feedstock 121, the pressure of the gas 131, and the electric power level results in control of partial vaporization of the feedstock 121 to a level such that enough carbon remains to facilitate a continuous line feed, as shown. As physical contact is required between the two electrodes 124, 125 and some of the carbon feedstock is vaporized, it is important to not vaporize all of the feedstock, thereby leaving sufficient material to provide continuous contact of the feedstock with the trailing and forward electrodes.

The apparatus 111 also includes inductance coils 141 mounted to the reactor 113 for stabilizing the carbon plasma 122 in a vapor phase in the plasma stabilization region 117 with radio frequency energy via controller 143. The carbon plasma is stabilized by controlling the power and a frequency of the radio frequency energy, such that the carbon plasma is stabilized for homogenization of a reactant mixture and transport of a high concentration of the carbon plasma to the product formation region 119. In addition, the apparatus 111 further comprises stabilizations means 151 (e.g., electrical resistance heaters) mounted to the reactor 113 for applying thermal energy inside the reactor 113 to maintain a reactor temperature of up to approximately 1700° C. In this way, the thermal energy reduces the radio frequency energy required to stabilize the carbon plasma 122, and promotes a higher concentration of carbon vapor in the reactor 113. Microwave energy also can be used for stabilization of the plasma using appropriate electrodes and power supply.

In the product formation region 119, a transition metal catalyst 161 is used for forming the product (carbon nanotubes 21) on the heat transfer surface 17. The flow stream is directed toward the build surface (substrate 15) where the swcnt layer is deposited. The flow rate, carbon concentration, pressure, and temperature are carefully regulated.

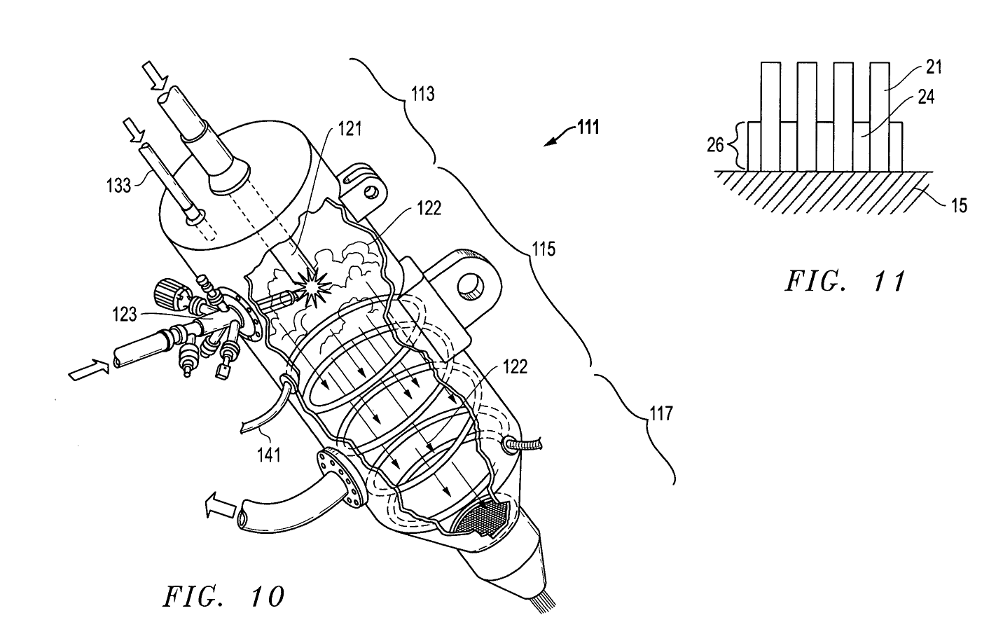

In one alternate embodiment of the present invention (FIG. 10), the apparatus 111 has means for generating the plasma 122 that comprises an electron beam device 123 that vaporizes the feedstock 121. An electron beam is focused on a graphite target with sufficient energy and spot size to rapidly heat the graphite target, creating a thermal carbon plasma. Beam dithering and graphite feed rate is optimized to provide complete consumption of the feedstock. Like apparatus 11, apparatus 111 comprises a continuous operation, flow-through reactor 113 having an initial plasma generation region 113, a plasma stabilization region 115, and a product formation region 117. The feedstock 121 is continuously supplied to the plasma generation zone 113 for generating a continuous stream of carbon plasma 122 from the feedstock 121. The apparatus 111 further comprises a reduced pressure inert atmosphere of continuously-flowing gas through supply 133. Apparatus 111 also includes inductance coils 141 for stabilizing the carbon plasma in a vapor phase with radio frequency energy. In addition, the apparatus 111 further comprises optional electrical resistance heaters for applying thermal energy to reduce the radio frequency energy required to stabilize the carbon plasma, and to promote a higher concentration of carbon vapor in the reactor.

The present invention has several advantages, including the ability to increase the heat transfer capacity of otherwise ordinary devices by an order of magnitude over conventional cooling fin-type solutions. Densely-packed and uniformly-dispersed carbon nanotubes depositions extend from the surface of the heat transfer device. Both pre-processing and post-processing layers are used to enhance the effectiveness and durability of the nanotubes coating. Since there is no need to machine and assemble cooling fins, the present invention also has a lower manufacturing cost than prior art solutions. Due to the large surface area of the compact carbon nanotubes, the overall size or space required by the present invention is significantly smaller than prior art designs since the carbon nanotube coating does not need as much projected area.

While the invention has been shown or described in only some of its forms, it should be apparent to those skilled in the art that it is not so limited, but is susceptible to various changes without departing from the scope of the invention.

1. An apparatus for transferring heat from an object, comprising:
a substrate having a surface and adapted to be mounted to an object for conducting heat away from the object;
a catalyst on the surface of the substrate;
carbon nanotubes uniformly deposited on the catalyst and extending away from the surface of the substrate, such that the carbon nanotubes conduct heat away from the substrate and, thus, the object along axial lengths of the carbon nanotubes.

2. The apparatus of claim 1, wherein the substrate is tubing and is formed from a material selected from the group consisting of iron, graphite, copper, and bronze.

3. The apparatus of claim 1, wherein the catalyst is a transition metal and is selected from the group consisting of Fe, Co, Mo, Ni, and Y.

4. The apparatus of claim 1, wherein the catalyst is deposited from a metal salt and pyrolyzed to remove an organic component of the metal salt.

5. The apparatus of claim 1, wherein the catalyst has a thickness of approximately 2 to 50 nm, and the carbon nanotubes have a thickness of approximately 5 microns to 1 mm.

6. The apparatus of claim 1, wherein a thickness of the carbon nanotubes is on the order of approximately 200 microns or less.

7. The apparatus of claim 1, further comprising a protective layer formed on the carbon nanotubes to facilitate retention of the carbon nanotubes on the substrate.

8. The apparatus of claim 7, wherein the protective layer is one of a metal or a carbon allotrope and is selected from the group consisting of silicon, gold, silver, and diamond.

9. The apparatus of claim 7, wherein the protective layer penetrates into the carbon nanotubes, fills voids between the carbon nanotubes, and deposits on an outer surface of the carbon nanotubes.

10. The apparatus of claim 7, wherein a portion of the protective layer is removed from an outer portion of the carbon nanotubes, such that the outer portion of the carbon nanotubes is exposed.

11. The apparatus of claim 7, wherein the protective layer has a thickness of approximately 30 microns.

12. A heat transfer device for dissipating heat from an object, comprising:
a substrate having an outer surface and adapted to be mounted to an object that generates heat for conducting heat away from the object;
a catalyst on the outer surface of the substrate;
carbon nanotubes uniformly deposited on the catalyst and extending away from the outer surface of the substrate in a substantially perpendicular configuration, such that the carbon nanotubes conduct heat away from the substrate and, thus, the object along axial lengths of the carbon nanotubes such that the substrate is void of cooling fins; and
a protective layer formed on the carbon nanotubes to facilitate retention of the carbon nanotubes on the substrate.

13. The heat transfer device of claim 11, wherein the catalyst is a transition metal and is selected from the group consisting of Fe, Co, Mo, Ni, and Y.

14. The heat transfer device of claim 11, wherein the catalyst is deposited from a metal salt and pyrolyzed to remove an organic component of the metal salt.

15. The heat transfer device of claim 11, wherein the protective layer is one of a metal or a carbon allotrope and is selected from the group consisting of silicon, gold, silver, and diamond.

16. The heat transfer device of claim 11, wherein the protective layer penetrates into the carbon nanotubes, fills voids between the carbon nanotubes, and deposits on an outer surface of the carbon nanotubes.

17. The heat transfer device of claim 11, wherein a portion of the protective layer is removed from an outer portion of the carbon nanotubes, such that the outer portion of the carbon nanotubes is exposed.

18. The heat transfer device of claim 11, wherein the catalyst has a thickness of approximately 2 to 50 nm, the carbon nanotubes have a thickness of approximately 5 microns to 1 mm, and the protective layer has a thickness of approximately 30 microns.

19. A method of forming and utilizing a heat transfer device, comprising:
(a) applying a catalyst to a substrate and heating the substrate to a selected temperature to facilitate carbon nanotube growth;
(b) uniformly depositing and growing carbon nanotubes on the catalyst such that the carbon nanotubes extend away from the substrate;
(c) mounting the substrate to an object that dissipates heat; and then
(d) conducting heat away from the object via the substrate along axial lengths of the carbon nanotubes.

20. The method of claim 19, wherein step (a) comprises dipping the substrate in a solution or metal salts and heating the substrate in a furnace to burn off acetates, sulfates, or nitrates, and step (c) comprises placing the substrate in a plasma jet atmosphere to form the carbon nanotubes thereon.

21. The method of claim 19, wherein an evacuated environment is not required in step (b).

22. The method of claim 19, wherein step (a) comprises selecting the catalyst from the group consisting of Fe, Co, Mo, Ni, and Y, and step (b) comprises forming the carbon nanotubes as one of single-walled carbon nanotubes or multi-walled carbon nanotubes.

23. The method of claim 19, wherein step (a) comprises depositing the catalyst from a metal salt and pyrolyzing the metal salt to remove an organic component thereof.

24. The method of claim 19, further comprising forming a protective layer on the carbon nanotubes to enhance a durability of the carbon nanotubes on the substrate.

25. The method of claim 24, wherein the forming step comprises depositing a carbon allotrope at a relatively lower temperature CVD process that bonds the carbon nanotubes together and provides adhesion to the substrate.

26. The method of claim 24, wherein the forming step comprises depositing a small amount of protective layer to partially fill in voids between the carbon nanotubes, and exposing top surfaces of the carbon nanotubes to transfer heat out of cylindrical walls of the carbon nanotubes.

27. The method of claim 26, wherein an extent of the filling in the voids between the carbon nanotubes in the forming step is controlled with parameters such as residence time.

28. The method of claim 24, wherein the forming step comprises selecting the protective layer from the group consisting of silicon, gold, silver, and diamond.

29. The method of claim 24, wherein the forming step comprises penetrating the protective layer into the carbon nanotubes, filling voids between the carbon nanotubes, and depositing on an outer surface of the carbon nanotubes.

30. The method of claim 24, wherein the forming step comprises removing a portion of the protective layer from an outer portion of the carbon nanotubes such that the outer portion of the carbon nanotubes is exposed.
